(19) United States
(12) Patent Application Publication
(10) Pub. No.: US 2012/0250953 A1
(43) Pub. Date: Oct. 4, 2012

(54) DOOR PHONE DEVICE, VISITOR EVALUATION METHOD, AND DOOR PHONE SYSTEM

(75) Inventor: Yasuo Nakano, Tokyo (JP)

(73) Assignee: SONY CORPORATION, Tokyo (JP)

(21) Appl. No.: 13/405,960

(22) Filed: Feb. 27, 2012

(30) Foreign Application Priority Data
Mar. 31, 2011 (JP) 2011-078313

(51) Int. Cl. G06K 9/00

(52) U.S. Cl. 382/118

(57) ABSTRACT

A door phone device includes a facial characteristics acquisition section which acquires facial characteristics from an image in which a visitor is imaged, an occupation attributes acquisition section which acquires occupation attributes of the visitor which has the same facial characteristics as the facial characteristics which are acquired by the facial characteristics acquisition section, and an action control section which determines an action according to the occupation attributes which are acquired by the occupation attributes acquisition section using registration information where the occupation attributes and the action are made to correspond in advance.

### CROSS REFERENCES TO RELATED APPLICATIONS

The present application claims priority to Japanese Priority Patent Application JP 2011-078313 filed in the Japan Patent Office on Mar. 31, 2011, the entire content of which is hereby incorporated by reference.

### BACKGROUND

The present disclosure relates to a door phone device, a visitor evaluation method, and a door phone system.

A current door phone (intercom) communicates a visit by a visitor who presses a calling button to a visited person without conditions with a calling sound irrespective of intensions of the visited person who is at home. Due to this, for example, through activation of the calling sound by a visitor, who has a business objective to which a response is not necessary, pressing the calling button when a visited person is sleeping, there are problems that the sleep of the visited person is disturbed, a response is prompted to the door-to-door sales of unneeded goods, and inadvertent contact with criminals or the like who pose as delivery people or the like is prompted.

The activation of the calling sound by a visitor to whom the visited person does not desire to respond is the same as unsolicited advertising emails, that is spam emails, and emails to which computer viruses are attached which are problems with electronic mail and conversation calling for illegal acts using a mobile phone. Accordingly, in a response system which uses a door phone, there is demand for a technique where unnecessary visitor notification is blocked without reporting of the visit by the visitor where it is not necessary for the visited person themselves to respond, in the same manner as a unwanted email filter function in electronic mail reception software or a mobile phone block function where a caller ID is not shown.

In order to respond to such a demand, a technique (Japanese Unexamined Patent Application Publication 2010-200067) where a calling report is not performed in a time slot which is set in advance, a technique (Japanese Unexamined Patent Application Publication 2007-172083) where a visitor is imaged using an imaging device which is provided with a door phone and there is no inadvertent contact when the visitor who has commonality of a suspicious individual in a region visits, and the like are disclosed.

### SUMMARY

However, the technique which is disclosed in Japanese Unexamined Patent Application Publication 2010-200067 is with regards to recognizing the appearance or the like of a visitor which is imaged using a camera of the door phone base using the display of the door phone extension and reflecting the intention of the response acceptance of the visited person with regard to the visitor such as determining whether or not to respond, but there is no automatic selection of the presence or absence of the calling report according to the occupation attributes of the individual visitors.

In addition, the technique which is disclosed in Japanese Unexamined Patent Application Publication 2007-172083 regards to generating a warning when a suspicious individual visits by polling the visited person on whether or not the visitor is a suspicious individual from the response result with regard to the visitor and the appearance of the visitor with regard to visitor attributes determination technology and there being commonality of a suspicious individual in a region, but the evaluation with regard to the visitor by the visited person is insufficient if there is two outcomes of there being a suspicious individual or not, and in the polling with two outcomes, there is a problem in that there is a possibility of a visitor who is not a suspicious individual being treated by a specific user as a suspicious individual.

In addition, for example, since a visitor posts a flyer in the mailbox creates a burden in that the resident who lives in the house has to handle the flyer, it is desirable to be able to block so that an unnecessary posting such as this is not posted if possible. That is, there is the same problem as the problem in that visitors may be unnecessary excluded with the door phone device as described above even with postings.

Therefore, it is desirable that a novel and improved door phone device, visitor evaluation method, and door phone system where, using the user's own intentions, it is possible to ignore a visit by visitor to whom the user does not wish to respond in advance, and to share visitor information on these unwelcomed visitors.

According to an embodiment of the present disclosure, there is provided a door phone device which is provided with a facial characteristics acquisition section which acquires facial characteristics from an image in which a visitor is imaged, an occupation attributes acquisition section which acquires occupation attributes of the visitor which has the same facial characteristics as the facial characteristics which are acquired by the facial characteristics acquisition section, and an action control section which determines an action according to the occupation attributes which are acquired by the occupation attributes acquisition section using registration information where the occupation attributes and the action are made to correspond in advance.

An occupation attributes evaluation section may be further provided which executes an evaluation with regard to the occupation attributes of the visitor which are acquired by the occupation attributes acquisition section.

The occupation attributes evaluation section may evaluate with regard to the occupation attributes of the visitor by only presenting certain occupation attributes.

In a case where the occupation attributes acquisition section is not able to determine the occupation attributes of the visitor who has the same facial characteristics as the facial characteristics which are acquired by the facial characteristics acquisition section, the action control section may execute an action which is determined in advance.

If the visited person themselves has previously evaluated the occupation attributes of the visitor, the occupation attributes acquisition section may acquire the occupation attributes which have been evaluated by the visited person as the occupation attributes of the visitor.

If the visited person themselves has previously evaluated the occupation attributes of the visitor, the occupation attributes acquisition section may acquire the evaluation result of the occupation attributes acquired by the other visited person as the occupation attributes of the visitor in a case where the evaluation result exceeds a predetermined threshold.

The facial characteristics acquisition section may acquire the facial characteristics from the image where the visitor is imaged in a case where an operation for calling the visited person is executed by the visitor.

The facial characteristics acquisition section may acquire the facial characteristics from the image where the visitor is imaged in a case where there is a posting in a mailbox by the visitor.

According to another embodiment of the present disclosure, there is provided a visitor evaluation method which includes acquiring facial characteristics from an image in which a visitor is imaged, acquiring occupation attributes of the visitor which has the same facial characteristics as the facial characteristics which are acquired in the acquiring of the facial characteristics, and determining an action according to the occupation attributes which are acquired in the acquiring of the occupation attributes using registration information where the occupation attributes and the action are made to correspond in advance.

According to another embodiment of the present disclosure, there is provided a door phone system which is provided with a door phone device which responds to a visitor and a database system which is connected to the door phone device via a network, where the door phone device is provided with a facial characteristics acquisition section which acquires facial characteristics from an image in which a visitor is imaged, an occupation attributes acquisition section which acquires occupation attributes of the visitor which has the same facial characteristics as the facial characteristics which are acquired by the facial characteristics acquisition section from the database system, and an action control section which determines an action according to the occupation attributes which are acquired by the occupation attributes acquisition section using registration information where the occupation attributes and the action are made to correspond in advance, and the database system records the facial characteristics of the visitor who has been evaluated by the door phone device and the occupation characteristics of the visitor so as to correspond to each other.

According to the embodiments of the present disclosure as described above, it is possible to provide a novel and improved door phone device, visitor evaluation method, and door phone system where, using the user's own intentions, it is possible to ignore a visit by visitor to whom the user does not wish to respond in advance, and to share visitor information on these unwelcomed visitors.

Additional features and advantages are described herein, and will be apparent from the following Detailed Description and the figures.

### BRIEF DESCRIPTION OF THE FIGURES

FIG. 1 is an explanatory diagram illustrating an overall configuration example of a door phone system according to an embodiment of the present disclosure;

FIG. 2 is an explanatory diagram illustrating a functional configuration of a door phone according to an embodiment of the present disclosure;

FIG. 3 is a flow diagram illustrating actions of a door phone system according to an embodiment of the present disclosure;

FIG. 4 is an explanatory diagram illustrating an example of a facial characteristics and occupation attributes evaluations table in user units which is included in a database system;

FIG. 5 is an explanatory diagram illustrating an example of a facial characteristics table in visitor units which is included in a database system;

FIG. 6 is an explanatory diagram illustrating an example of an occupation attributes selection result table which is included in a database system; and

FIG. 7 is an explanatory diagram illustrating an example of an action table for each base.

### DETAILED DESCRIPTION

An embodiment of the present disclosure will be described in detail while referencing the attached diagrams below. Here, overlapping description with regard to the constituent elements which have the same functional configuration in practice in the specification and the diagrams will be omitted by attaching the same reference numerals.

Here, the description will be performed in the following order.

### <1. First Embodiment>

### [1-1. Overall System Configuration]

### [1-2. Overall Door Phone Configuration Example]

### [1-3. Actions of System]

### <2. Conclusion>

### 1. First Embodiment

### [1-1. Overall System Configuration]

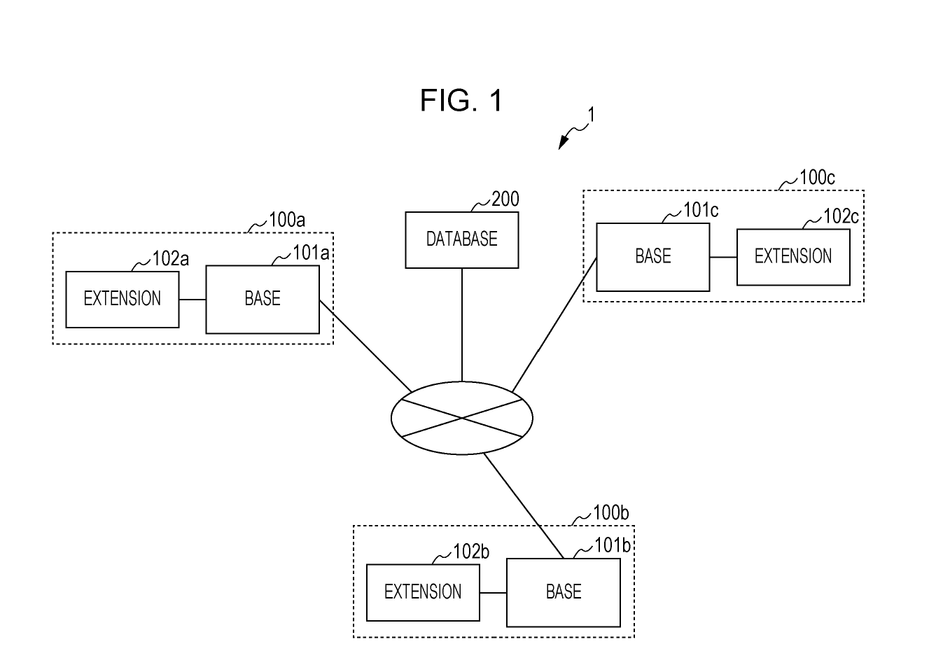

First, an example of an overall configuration of a door phone system according to an embodiment of the present disclosure will be described with reference to the diagrams. FIG. 1 is an explanatory diagram illustrating an overall configuration example of a door phone system according to the embodiment of the present disclosure. Below, the overall configuration of a door phone system according to the embodiment of the present disclosure will be described using FIG. 1.

As shown in FIG. 1, a door phone system 1 according to the embodiment of the present disclosure is configured to include door phones 100a, 100b, and 100c, and a database system 200, and has a configuration where the door phones 100a, 100b, and 100c, and the database system 200 are connected to each other via a network 10.

The door phones 100a, 100b, and 100c are provided for each household and are used for a visited person to respond to a visit by a visitor. Each of the door phones are respectively configured from bases 101a, 101b, and 101c and extensions 102a, 102b, and 102c.

The bases 101a, 101b, and 101c are devices that are provided in the household and the extensions 102a, 102b, and 102c are devices which are provided outside the household, such as at the side of the door. Below, when an example of a combination of a door phone 101a and an extension 102a is described as an example, the base 101a and the extension 102a are provided with a conversion function using audio to each other and it is possible to perform a conversation using the base 101a and the extension 102a between the visitor and the visited person when visiting is communicated by the button which is provided in the extension 102a being pressed by the visitor and the visited person responds with regard to the visit by the visited person operating the base 101a.

Detailed configurations and actions will be described later, but the extension 102a according to the embodiment is provided with an imaging device which images the visitor, and the base 101a according to the embodiment is not only able to display a video which is imaged by the imaging device which is provided in the extension 102a but also to acquire attributes of the visitor using the video which is imaged by the imaging device and execute actions according to the attributes of the visitor which are acquired.

The base 101a is connected to the database system 200 via the network 10. In the database system 200, an image which is imaged by the extension 102a of the door phone 100a, information which identifies the time and data of the imaging, the position of the imaging and/or the extension 102a, the characteristics of the face which was imaged, information on the attributes of the visitor, and the like are stored. The base 101a searches the database system 200 when the button of the extension 102a is pressed by a visitor, acquires the attributes of the visitor, and executes an action according to the attributes of the visitor which are acquired.

Here, in the embodiment, three combinations of the bases and the extensions are shown in FIG. 1, but needless to say, the present disclosure is not limited to this example. In addition, one of each of the base and the extension configure one combination in the embodiment, but there may be a configuration where a plurality of bases correspond to one extension as in, for example, the entrance of an apartment building.

Above, the overall configuration example of the door phone system according to the present disclosure has been described using FIG. 1. Next, the functional configuration of a door phone according to the embodiment of the present disclosure will be described.

### [1-2. Overall Door Phone Configuration Example]

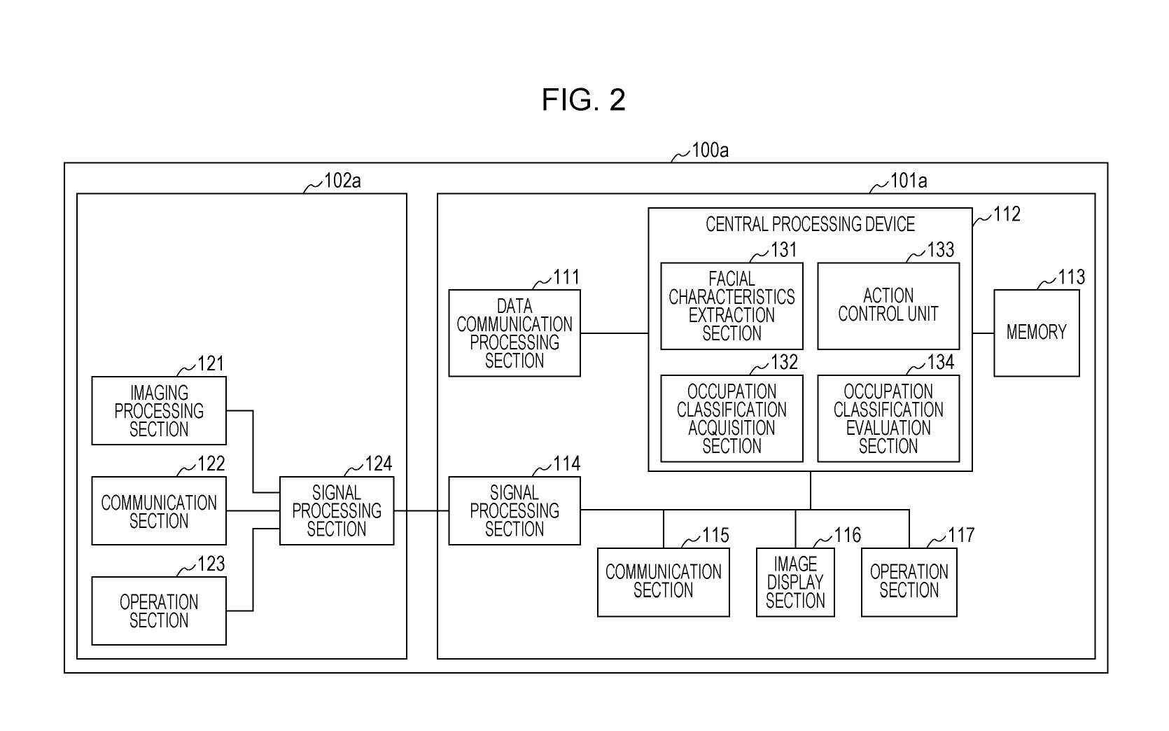

FIG. 2 is an explanatory diagram illustrating the functional configuration of a door phone 100a according to the embodiment of the present disclosure. Below, the functional configuration of the door phone 100a according to the embodiment of the present disclosure will be described using FIG. 2.

As shown in FIG. 2, the base 101a of the door phone 100a according to the embodiment of the present disclosure is configured to include a data communication processing section 111, a central processing device 112, a memory 113, a signal processing section 114, a communication section 115, an image display section 116, and an operation section 117.

In addition, as shown in FIG. 2, the extension 102a of the door phone 100a according to the embodiment of the present disclosure is configured to include an imaging processing section 121, a communication section 122, an operation section 123, and a signal processing section 124.

As described above, the base 101a of the door phone 100a is a device which is provided in the household and it is possible to perform a conversation using the base 101a and the extension 102a between the visitor and the visited person when visiting is communicated by the operation section 123 which is provided in the extension 102a being pressed by the visitor and the visited person responding with regard to the visit by the visited person operating the base 101a. First, the configuration of each section which is included in the base 101a will be described.

The data communication processing section 111 executes data communication with the database system 200. Specific actions will be described later, but the attributes of the visitor are determined based on the image which is imaged by the extension 102a when the visit is communicated by the operation section 123 which is provided in the extension 102a being pressed by the user. The data communication processing section 111 executes necessary data communication with the database system 200 in order to determine the attributes of the visitor.

The central processing device 112 controls the actions of each section which is included in the base 101a. In addition, the central processing device 112 has a function of extracting facial characteristics of the visitor from the image which is imaged by the extension 102a. The memory 113 records the data as necessary when action controlled by the central processing section 112.

As shown in FIG. 2, the central processing device 112 is configured to include a facial characteristics extraction section 131, an occupation attributes acquisition section 132, an action control section 133 and an occupation attributes evaluation section 134.

The facial characteristics extraction section 131 extracts the facial characteristics of the visitor from the image which is imaged by the extension 102a. The facial characteristics which are extracted by the facial characteristics extraction section 131 are used to acquire the occupation attributes of the visitor. Here, the facial characteristics extraction process by the facial characteristics extraction section 131 according to the embodiment is not limited to a specific process.

The occupation attributes acquisition section 132 executes a search of the occupation attributes with regard to the database system 200 using the facial characteristics of the visitor which are extracted by the facial characteristics extraction section 131 and acquires information on the occupation attributes. The information on the occupation attributes which are acquired by the occupation attributes acquisition section 132 is used in the action control of the base 101a by the action control section 133.

The action control section 133 controls the actions of the base 101a based on the occupation attributes which are acquired by the occupation attributes acquisition section 132. The details will be described later, but the action control section 133 performs control by executing actions which are determined in advance in a case where the occupation attributes acquisition section 132 is not able to acquire the occupation characteristics.

The occupation attributes evaluation section 134 evaluates the occupation attributes of the visitor with regard to the visited person. The occupation attributes evaluation section 134 registers the evaluation result in the database system 200 when the occupation attributes of the visitor are evaluated by the visited person.

The central processing device 112 is able to control the actions of each section which is included in the base 101a by having a configuration as shown in FIG. 2, and it is possible for the actions of the base 101a to be control based on the occupation attributes which have been acquired by extracting the facial characteristics of the visitor from the image which is imaged by the extension 102a and acquiring the occupation attributes based on the facial characteristics which have been extracted.

The signal processing section 114 executes a transfer signal process with the signal processing section 124 which is included in the extension 102a. It is possible for the base 101a to execute a communication process with the extension 102a by the signal processing section 114 executing the transfer signal process with the signal processing section 124. In addition, the signal processing section 114 executes a communication process between the base 101a and the database system 200 via the network 10.

The communication section 115 is for the visited person who uses the base 101a to communicate with the visitor who is using the extension 102a, and for example, is configured to include a speaker and a microphone. The image display section 116 displays video which is imaged by the image processing section 121 which is included in the extension 102a. The operation section 117 is for receiving an operation input with regard to the base 101a by the visited person who uses the base 101a. As the format of the operation section 117, there may be a button which is provided in the main body of the base 101a or there may be a touch panel or the like which is integral with the image display section 116.

Above, the configuration of each section which is included in the base 101a has been described. Next, the configuration of each section which is included in the extension 102a will be described.

The imaging processing section 121 executes an imaging process of an object, and for example, may include a camera section which performs the imaging of the object, an imaging processing section which performs image processing with regard to the image which is imaged by the camera section, and the like. In addition, the camera section may be provided with a CCD image sensor, a CMOS image sensor, or another photoelectric conversion element as an imaging element. The image which is imaged by the imaging processing section 121 is sent to the base 101a via the signal processing section 124 and outputs the image display section 116 of the base 101a.

The communication section 122 is for the visitor who uses the extension 102a to communicate from inside of the household with the visited person who uses the base 101a. The communication section 122 is, for example, configured to include a speaker or a microphone.

The operation section 123 is for receiving an operation input with regard to the extension 102a by the visitor who uses the extension 102a. As the format of the operation section 123, for example, there may be a calling button for communicating the visit of the visitor. The visitor operates the operation section 123 for reporting the visit with regard to the visited person who is in the house.

The signal processing section 124 executes a transfer signal process of the signal with the signal processing section 114 which is included in the base 101a. The extension 102a is able to execute the communication process with the base 101a by the signal processing section 124 executing a transfer signal process with the signal processing section 114.

Above, the configuration of each section which is included in the extension 102a has been described. Next, actions of the door phone system 1 according to an embodiment of the present disclosure will be described.

### [1-3. Actions of System]

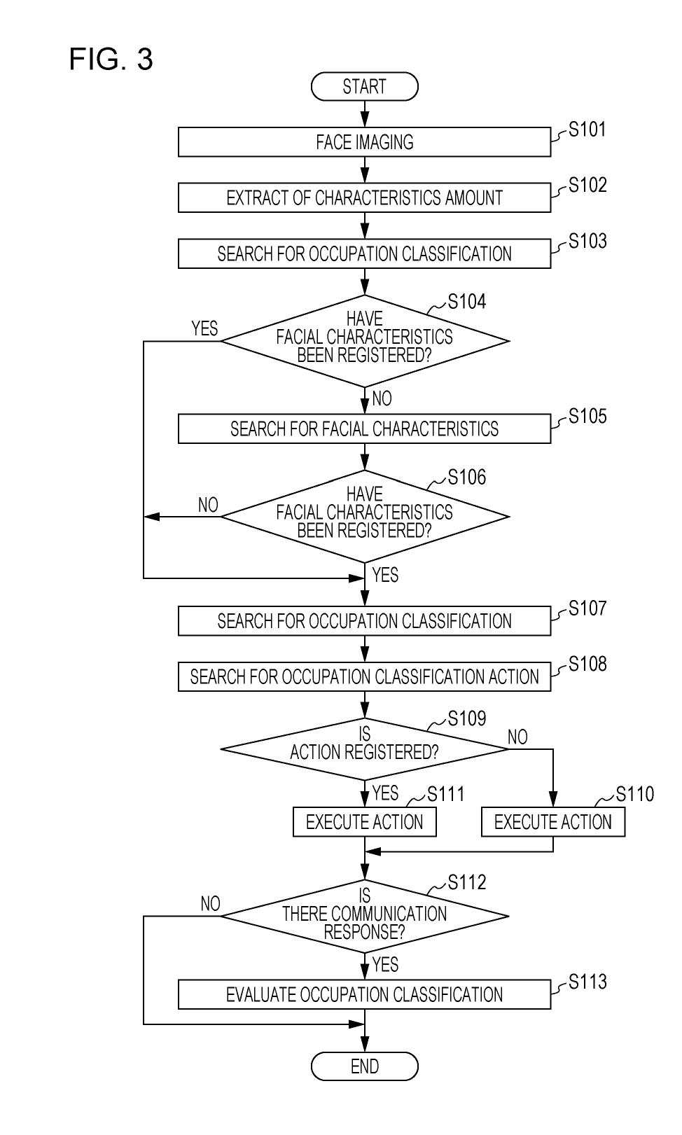

FIG. 3 is a flow diagram illustrating actions of the door phone system 1 according to the embodiment of the present disclosure. The flow diagram of FIG. 3 describes in detail with regard to the action by the visitor operating the operation section 123 of the extension 102a and the visit being communicated with regard to the visited person. Below, actions of the door phone system 1 according to the embodiment of the present disclosure will be described using FIG. 3.

When the visit is communicated with regard to the visitor by the visitor operating the operation section 123 of the extension 102a, the imaging processing section 121 starts the object imaging process. The imaging processing section 121 images an image which includes the face of the visitor who operates the operation section 123 due to the imaging process being started (step S101).

When the imaging processing section 121 images the face of the visitor in step S101 described above, the image data of the face of the visitor who has been imaged is sent to the base 101a via the signal processing section 124. Then, the extraction of the facial characteristics amount using the image data of the face of the visitor who has been imaged (step S102). The facial characteristics amount extraction process may be performed using the base 101a of the door phone 100a or may be performed using the database system 200 by transferring the image data from the base 101a to the database system 200.

When the facial characteristics amount is extracted from the image data of the face of the visitor in step S102 described above, whether or not the visited person themselves has previously evaluated the occupation attributes of the visitor is searched for using the facial character amount which has been extracted (step S103). The occupation attributes of the visitor are performed by the information of the occupation attributes corresponding to the visitor which is stored in the database system 200 being searched for. Accordingly, the search instruction of the occupation attributes of the visitor may be executed by the central processing device 112 of the base 101a or may be performed by a signal processing section (not shown) which is included in an inner portion of the database system 200.

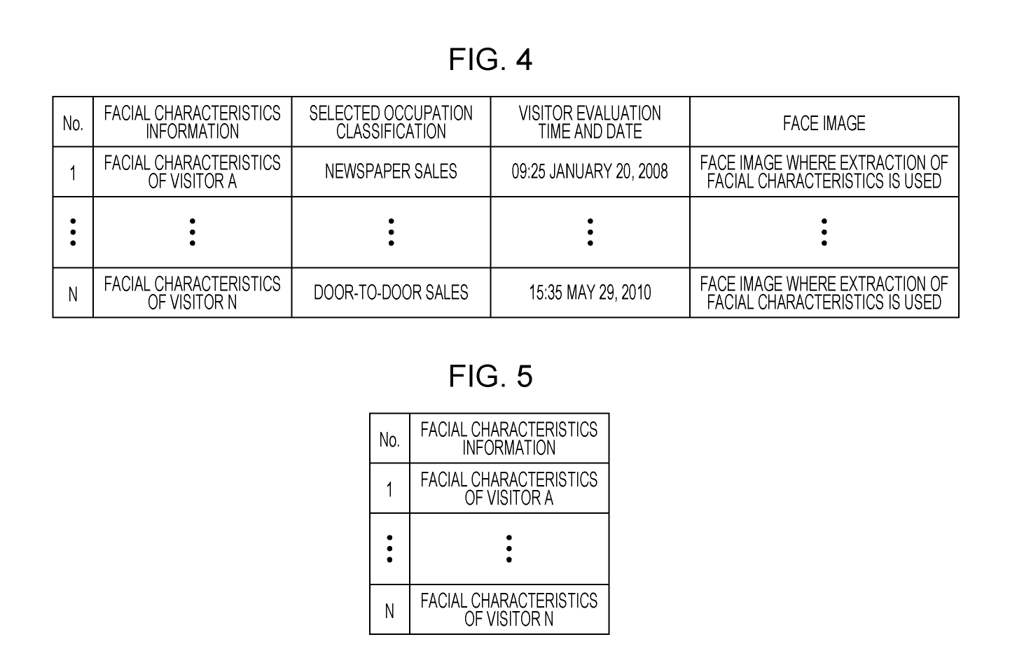

FIG. 4 is an explanatory diagram illustrating an example of a facial characteristics and occupation attributes evaluations table in user units which is included in the database system 200 according to the embodiment of the present disclosure. In FIG. 4, visitor facial characteristics information, occupation attributes of the visitor which has the facial characteristics which are selected by the user, the evaluation date and time of the visitor, and the face image of the visitor which is imaged by the imaging processing section 121 are shown as the information which is registered in the facial characteristics and occupation attributes evaluation table.

In this manner, in a case where the visited person themselves has previously evaluated the occupation attributes of the visitor, the evaluation result may be heeded and following processes may be executed using this occupation attributes of the visitor.

It is determined whether or not the visited person themselves has previously evaluated the occupation attributes of the visitor using the facial characteristics amount which have been extracted in step S102 described above by searching for the occupation attributes of the visitor in the database system 200 (step S104). If the visited person themselves has not previously evaluated the occupation attributes of the visitor, next, the facial characteristics which are stored in the database system 200 are search for using the facial characteristics amount which have been extracted in step S102 described above (step S105).

FIG. 5 is an explanatory diagram illustrating an example of a facial characteristics table in visitor units which is included in the database system 200 according to the embodiment of the present disclosure. In FIG. 5, the facial characteristics information of the visitor is shown as the information which is registered in a facial characteristics table. In the facial characteristics table, the information on the facial characteristics which is registered by each of the users of the door phone system 1 is stored in visitor units. It is possible to determine whether or not the visitor has visited in the past (including other houses) by searching the facial characteristics which are stored in the database system 200 using the facial characteristics amount.

It is determined whether or not the facial characteristics amount which is extracted in S102 described above are registered in the facial characteristics table in the database system 200 (step S106). If the facial characteristics amount which is extracted in S102 described above are registered in the facial characteristics table in the database system 200, the occupation attributes which are evaluated and set by another user is search for using the facial characteristics which are registered (step S107).

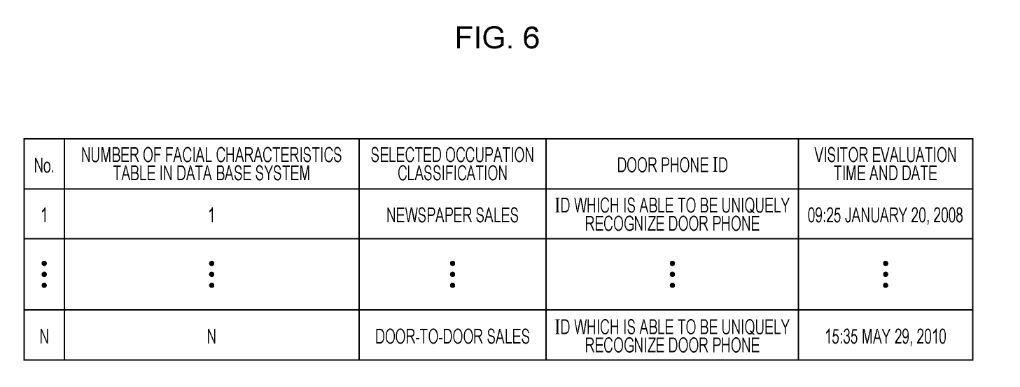

FIG. 6 is an explanatory diagram illustrating an example of an occupation attributes selection result table which is included in the database system 200 according to the embodiment of the present disclosure. In FIG. 6, a row number of the facial characteristics table which is shown in FIG. 5, the occupation attributes which are selected by the user, ID information of the door phone of the user which is selected, and the evaluation date and time of the visitor is shown as an example of information which is registered in an occupation attributes selection result table.

In the embodiment, the occupation attributes which are adopted as the result of the evaluation of the most users is adopted as the occupation attributes of the visitor.

Next, an action table in occupation attributes units which are registered for each base in advance is searched using the occupation attributes of the visitor which are determined by the process which is described above (step S108). As a result of the action table in the occupation attributes units being searched, it is determined whether or not there is registration of the action of the base 101a with regard to the occupation attributes (step S109). Here, in a case where the occupation attributes of the visitor are not set in the process described above, there is no registration of the action of the base 101a with regard to the occupational attributes.

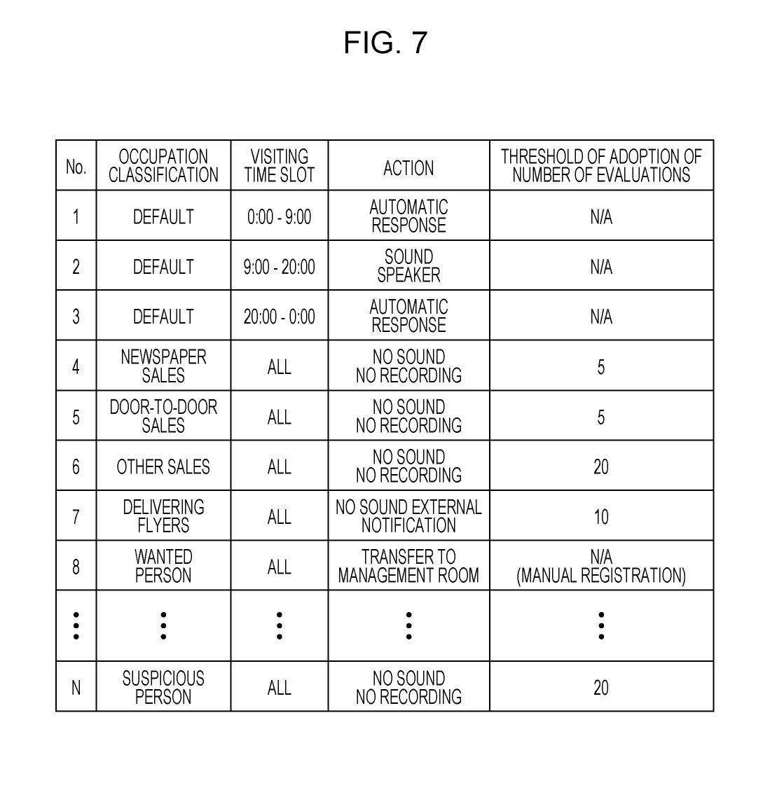

FIG. 7 is an explanatory diagram illustrating an example of an action table for each base according to the embodiment of the present disclosure. In FIG. 7, the occupation attributes of the visitor, a visit time slot of the visitor, an action with regard to the operation of the base by the visitor, and a threshold of adoption of number of evaluations are shown as an example of the information which is registered in the action table. The threshold of adoption of number of evaluations indicates that the action is adapted by the base if the users which have evaluated the occupation attributes exceed the threshold.

For example, in a case where the facial characteristics information of the visitor is not registered in the database system 200, and as a result, the occupation attributes of the visitor are not able to be determined, the action control section 133 sets an action where the occupation attributes of the visitor are set as a “default” according to the visit time slot of the visitor. The action control section 133 controls the action of the base 101a based on an action which has been determined.

In the example shown in FIG. 7, in a case where a visitor such as this visits between from 9:00 to 20:00, the action control section 133 which is included in the central processing device 112 reports that the visitor has come with regard to the visited person by activating the speaker which is included in the communication section 115. In a case where a visitor such as this visit in a time slot other than this, the action control section 133 which is included in the central processing device 112 does not activate the speaker which is included in the communication section 115 and an automatic response process is executed with the extension 102a.

In addition, when it is determined that the occupation attributes of the visitor are “newspaper sales” in the series of processes which are described above, the action control section 133 which is included in the central processing device 112 does not activate the speaker which is included in the communication section 115 irrespective of the time slot and the information of the facial characteristics of the visitor are also not recorded in the database system 200.

In this manner, it is possible for the base 101a to automatically determine response or no response according to the occupation attributes of the visitor and to not respond where there is no necessity with regard to the visitor using the determination of the action based on the occupation attributes by imaging the visitor and acquiring the occupation attributes of the visitor from the facial characteristics which have been extracted from the imaging image.

If it is determined that there is not registration of the actions of the base 101a with regard to the occupation attributes of the visitor in step S109 described above, the base 101a executes the default action using the action table which is shown in FIG. 7 (step S110). On the other hand, if it is determined that there is registration of the actions of the base 101a with regard to the occupation attributes of the visitor in step S109 described above, the base 101a executes a predetermined action according to the registration (step S111). The predetermined action is executed by the control of the action control section 133.

When the base 101a executes the action with regard to the visit by the visitor, next, it is determined whether or not there was a communication response of the visited person using the base 101a with regard to the visitor (step S112). The determination is executed by the action control section 133 of the central processing device 112.

In a case where the result of the determination of step S112 described above determines is that there was a communication response of the visited person using the base 101a, an evaluation of the occupation attributes of the visitor is executed in the base 101a (step S113).

Here, as described above, in a case where the facial characteristics information of the visitor is not registered in the database system 200 and the occupation attributes of the visitor are not determined, the base 101a executes an action where the occupation attributes of the visitor are set as a “default” according to the time slot. The execution of the action is control by the action control section 133 of the central processing device 112. At this time, when the visited person actually perform a response to the visitor using the communication section 115, the extension 102a captures the face image at the time when the visited person has a conversation with the visitor and the action control section 133 which is included in the central processing section 112 of the base 101a selects whether to perform the evaluation of the occupation attributes of the visitor with regard to the visited person when the conversation of the visited person with the visitor ends.

When the visited person selects to execute an evaluation of the occupation attributes of the visitor, the facial characteristics extraction section 131 of the base 101a extracts the facial characteristics of the visitor using the central processing device 112. When the facial characteristics have been extracted, a facial characteristics and occupation attributes list of the visitor is displayed on the image display section 116 using the action control section 133 of the central processing device 112.

The base 101a selects the occupation attributes which most probably expresses the visitor by the visited person using the operation section 117 by the facial image and occupation attributes list of the visitor being displayed on the image display section 116. The occupation attributes list may be updated by the base 101a periodically inputting from the database system 200 or may be acquired from the database system 200 by the base 101a each time an evaluation of the visitor by the visited person is executed.

If the visited person selects the occupation attributes, the occupation attributes evaluation section 134 which is included in the central processing device 112 of the base 101a registers the facial characteristics data, the occupation attributes, the imaging time and date, and the imaging position (which may be information which identifies the extension 102a which images) to the database system 200 via the data communication processing section 111. Here, the facial characteristics data may be extracted using the database system 200 and not the base 101a. In this case, the image data is sent to the database system 200 from the base 101a instead of the facial characteristics data.

The occupation attributes evaluation section 134 is able to link the occupation attributes which have been evaluated by the visited person the facial characteristics data using the registration of the information which is related to the series of occupation attributes which are described above in the database system 200 via the data communication processing section 111.

Here, when an incorrect registration is carried out with regard to a certain occupation attributes by the visited person, there is a concern that there is a risk of crime. For example, when it is registered in the database system 200 by a visited person that the visitor is a safe visitor even if the visitor is a wanted criminal or a suspicious individual due to an incorrect registration, there is a problem that the base of another house which uses the door phone system 1 determines that the visitor is a safe visitor and the visited person has contact with a unnecessary visitor imposed upon them when the visitor visits the house.

Therefore, with regard to a predetermined occupation attributes, selection options may be excluded when the occupation attributes are not able to be registered with regard to the facial characteristics only in the database system 200 or the occupation attributes are selected by the visited person using the base 101a. Here, as the predetermined occupation attributes, for example, civil servants, delivery personal, bill collectors for public broadcasting, measurers or inspectors of electricity, gas, or water, deliverers of takeaways such as pizza, sushi, or the like may be included. These occupational attributes are easy to use since the visited person at the visit destination is able to respond by the visited person themselves as identification is revealed.

However, when evaluating the occupation attributes, if the predetermined occupation attributes are excluded from the selection options in this manner, there is a concern that the visited person is not able to select the predetermined occupation attributes and this is troublesome. Accordingly, with regard to predetermined occupation attributes such as these, the inability to select may be set by presenting a reason for being unable to select when the visited person is selecting.

In addition, with regard to the facial characteristics which are considered to be a crime risk such as a wanted criminal, the occupation attributes may be created and registered in the database system 200 in advance and may be presented to the user. In addition, it may be possible to change the response action of the base 101a from the network 10 according to a request from a government or local body, for example, a request from the police, fire, or ambulance services, and in addition, it may be possible to change the response action of the base 101a by presenting a predetermined secret image pattern instead of the face image.

In addition, the evaluation of the occupation attributes of the visitor is determined using the visited person who responds according to whether or not the evaluation result of the occupation attributes is correct using the process described above. That is, there may be cases where the visited person responds by activating the speaker from the evaluation result of the action table shown in FIG. 7, but the other party which was responded to is a visitor with an occupation attributes which are to be set by the visited person so as not to correspond in the action table.

As the cause of the erroneous determination, for example, cases are able to be considered where the search result using the facial characteristics is erroneous or mistaken or the facial characteristics and the occupation attributes are incorrectly linked and registered in the database system 200. In a case such as this, it is possible for further erroneous determined to be prevented by an opportunity for the occupation attributes of the visitor to be evaluated after a conversation with the visited person is given to the visited person.

Above, the actions of the phone door system 1 according to the embodiment of the present disclosure have been described using FIG. 3.

### 2. Conclusion

According to the embodiment which are described above, it is possible for the base 101a of the door phone 100a to report the visit of the visitor where a response is necessary for the visited person who uses the door phone 100a, to identify visitors where a response is not necessary, and to execute an action which is for each visitor.

The information of the visitor is able to be shared with other users using the door phone system 1 who share the database system 200. It is possible for the visit of an unnecessary visitor, where visits are concentrated in a region where a group of users live such as in the same town or apartment building, to be effectively ignored.

Above, the embodiment of the present disclosure has been described while referencing the attached diagrams, but the present disclosure is not limited to this example. If it is a person skill in the art of the technology which the present disclosure belongs, it is clear that various modifications and alterations are conceivable in the technical scope which is disclosed in the range of the present disclosure, and with regard to these, it is to be understood as naturally belonging to the technical scope of the present disclosure.

For example, in the embodiment described above, the visitor is imaged by the extensions 102a, 102b, and 102c of the door phones 100a, 100b, and 100c which are provided at the entrances and the actions of the bases 101a, 101b, and 101c are controlled by the occupation attributes being identified based on the facial characteristics of the visitor, but the present disclosure is not limited to this. For example, a device which is similar to the imaging processing section 121 which is provided in the extensions 102a, 102b, and 102c is provided in the mailbox and the face image of the person who posted mail or a flyer is recording using the bases 101a, 101b, and 101c.

After this, using the bases 101a, 101b, and 101c, the users register the face images in the database system 200 by attributes into the occupation attributes using the postings. Due to this, when a person who attempts to post a flyer which is not necessary for the user stands in front of the mailbox, it is possible for there to be control from the bases 101a, 101b, and 101c so that the mailbox is locked and the flyer is not able to be posted.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A door phone device comprising:
a facial characteristics acquisition section which acquires facial characteristics from an image in which a visitor is imaged;
an occupation attributes acquisition section which acquires occupation attributes of the visitor which has the same facial characteristics as the facial characteristics which are acquired by the facial characteristics acquisition section; and
an action control section which determines an action according to the occupation attributes which are acquired by the occupation attributes acquisition section using registration information where the occupation attributes and the action are made to correspond in advance.

2. The door phone device according to claim 1, further comprising:
an occupation attributes evaluation section which executes an evaluation with regard to the occupation attributes of the visitor which are acquired by the occupation attributes acquisition section.

3. The door phone device according to claim 2,
wherein the occupation attributes evaluation section evaluates with regard to the occupation attributes of the visitor by presenting only certain occupation attributes.

4. The door phone device according to claim 1,
wherein in a case where the occupation attributes acquisition section is not able to determine the occupation attributes of the visitor which has the same facial characteristics as the facial characteristics which are acquired by the facial characteristics acquisition section, the action control section executes an action which is determined in advance.

5. The door phone device according to claim 1,
wherein if the visited person themselves has previously evaluated the occupation attributes of the visitor, the occupation attributes acquisition section acquires the occupation attributes which have been evaluated by the visited person as the occupation attributes of the visitor.

6. The door phone device according to claim 1,
wherein if the visited person themselves has previously evaluated the occupation attributes of the visitor, the occupation attributes acquisition section acquires the evaluation result of the occupation attributes acquired by the other visited person as the occupation attributes of the visitor in a case where the evaluation result exceeds a predetermined threshold.

7. The door phone device according to claim 1,
wherein the facial characteristics acquisition section acquires the facial characteristics from the image where the visitor is imaged in a case where an operation for calling the visited person is executed by the visitor.

8. The door phone device according to claim 1,
wherein the facial characteristics acquisition section acquires the facial characteristics from the image where the visitor is imaged in a case where there is a posting in a mailbox by the visitor.

9. A visitor evaluation method comprising:
acquiring facial characteristics from an image in which a visitor is imaged;
acquiring occupation attributes of the visitor which have the same facial characteristics as the facial characteristics which are acquired in the acquiring of the facial characteristics; and
determining an action according to the occupation attributes which are acquired in the acquiring of the occupation attributes using registration information where the occupation attributes and the action are made to correspond in advance.

10. A door phone system comprising:
a door phone device which responds to a visitor; and
a database system which is connected to the door phone device via a network,
wherein the door phone device is provided with a facial characteristics acquisition section which acquires facial characteristics from an image in which a visitor is imaged, an occupation attributes acquisition section which acquires occupation attributes of the visitor which have the same facial characteristics as the facial characteristics which are acquired by the facial characteristics acquisition section from the database system, and an action control section which determines an action according to the occupation attributes which are acquired by the occupation attributes acquisition section using registration information where the occupation attributes and the action are made to correspond in advance, and
wherein the database system records the facial characteristics of the visitor who has been evaluated by the door phone device and the occupation characteristics of the visitor so as to correspond to each other.
